(19) United States
(12) Patent Application Publication
(10) Pub. No.: US 2002/0155775 A1
(43) Pub. Date: Oct. 24, 2002

(54) Lightweight rug

(76) Inventor: J. Smith Capel, Troy, NC (US)

Correspondence Address: KENNEDY COVINGTON LOBDELL & HICKMAN, LLP, 100 N TRYON STREET, BANK OF AMERICA CORPORATE CENTER, CHARLOTTE, NC, 28202-4006, US

(21) Appl. No.: 09/785,818

(22) Filed: Feb. 16, 2001

(51) Int. Cl. B32B 5/02; B32B 27/12; D03D 15/00; D03D 25/00; B32B 5/26; B32B 7/12

(52) U.S. Cl. 442/263; 442/239; 442/149; 442/181

(57) ABSTRACT

A stable, inexpensive, lightweight, non-reversible rug having an upper layer of loosely woven flaccid material of the type conventionally used for reversible bathmats and kitchen rugs of a weight of ¼ to ⅓ pound per square foot. A duck backing layer is bonded to the upper layer by latex adhesive material rendering the rug dimensionally stable but non-reversible. A border strip is bonded to the peripheral portion of the duck backing layer and the adjacent portion of the border of the upper layer. The weight of the rug being approximately ½ pound per square foot or less.

### FIELD OF THE INVENTION

The present invention relates to rugs, and more particularly to lightweight multi-layered stable woven rugs.

### BACKGROUND OF THE INVENTION

The present invention provides a unique adaptation of inexpensive, thin, lightweight, loosely woven, flaccid, small rug pieces into stable larger rugs. Thin, lightweight, loosely woven rugs can be made inexpensively. They are usually woven of chenille yarn, flat yam or Jacquard woven fabric. These rugs are used in bathrooms and/or kitchens where they have the advantage of being reversible and sufficiently flaccid to be machine washable. However, because they are thin and flaccid, they are not capable of practical use in sizes much larger than bathmats because they are so unstable.

Typically these rugs may be ⅛ inch thick and weigh in the general range of ¼ to ⅓ pound per square foot. It would be possible to bulk up these rugs to have sufficient stability to be made in large sizes for general rug use, but to do so they would have to be made sufficiently dense to weigh more than approximately ½ pound per square foot or more. Obviously, this increases the cost of the rug that is otherwise desirable because of its low cost, which advantage is lost if the rug is made heavy enough to be stable.

By the present invention, the thin, lightweight woven rug fabric is combined with inexpensive backing material such as cotton duck fabric that is bonded by an adhesive, such as latex adhesive material to the underside of the woven rug fabric to provide stability and weight sufficient for the rug to now be used as a large general purpose rug. However, the conventional purposes of these rugs of being reversible and machine washable are eliminated as the rug is now non-reversible and too stiff to be machine washable, but it is now at a competitive cost advantage in comparison with other types of general purpose rugs of the same size.

Latex adhesive and backing material are used on other types of rugs, but not for the purpose of adapting an inexpensive, thin, flaccid bathmat type fabric to provide a stable general purpose rug, because this would result in non-reversibility of a rug that by convention is intended to be reversible. For example, tufted rugs use a backing in which the tufts are inserted and latex spread over the backing and back of the yam tufts with a squeegee or paddle, to retain the tufts in place, which is a different purpose than the use in the present invention.

Attempts have been made in the past to increase the weight of these woven rugs without the backing so that they are dimensionally stable for use as larger size rugs. However, increasing the weight has resulted in an increase in the raw material needed and the resulting price such that the rugs no longer maintained an inexpensively competitive advantage.

### SUMMARY OF THE INVENTION

The rug of the present invention is lightweight and stable. It is formed with an upper layer of inexpensive lightweight, relatively flaccid woven material, a backing layer of inexpensive backing material and an intermediate layer of adhesive material bonding the backing layer to the upper layer to form the lightweight stable rug.

Preferably, the rug is either loosely woven chenille yarn, loosely woven flat yarn or a Jacquard loosely woven fabric. The yarns are preferably made of cotton. The upper layer, in the preferred embodiment, weighs approximately ⅓ pound per square foot or less. The intermediate layer is preferably latex adhesive material and the backing layer is preferably cotton duck. To retain the edges of the backing layer bonded to the upper layer, the backing layer is of lesser peripheral extent than the upper layer to provide a border for application of a border strip that partially overlays the upper layer border and the adjacent portion of the backing layer, with the border strip being bonded to both the upper and backing layers by, preferably, a latex adhesive material. The combination of the upper and backing layers, the bonding material, and the border strip is of a weight less than ½ pound per square foot.

The various features and advantages of the present invention will be apparent from the following detailed description of the preferred embodiment with reference to the accompanying drawings.

### BRIEF DESCRIPTION OF THE DRAWINGS

FIG. 1 is a perspective view of the top of a rug incorporating the preferred embodiment of the present invention;

FIG. 2 is a perspective view of the underside of the rug of FIG. 1;

FIG. 3 is an enlarged perspective view of the underside of the rug of FIG. 2 with one comer of the backing layer and border strip turned up to expose the intermediate layer of latex bonding material;

FIG. 4 is a vertical sectional view taken along Line 4-4 of FIG. 1;

FIG. 5 is an enlarged vertical sectional view of the portion of the rug of FIG. 4 enclosed in dash lines; and

FIGS. 6(a)-6(f) are perspective views illustrating the sequential steps in the manufacture of the rug of FIG. 1.

### DETAILED DESCRIPTION OF THE PREFERRED EMBODIMENT

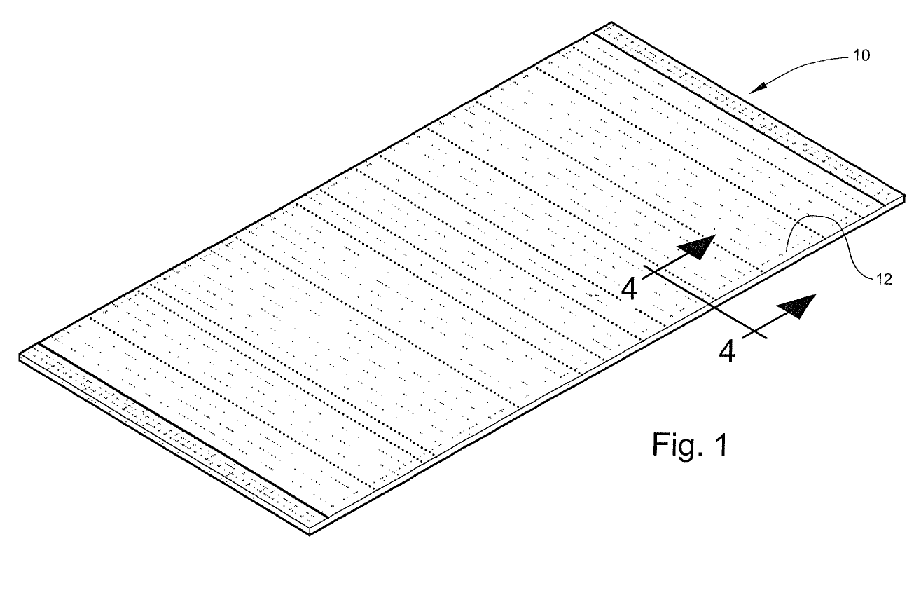

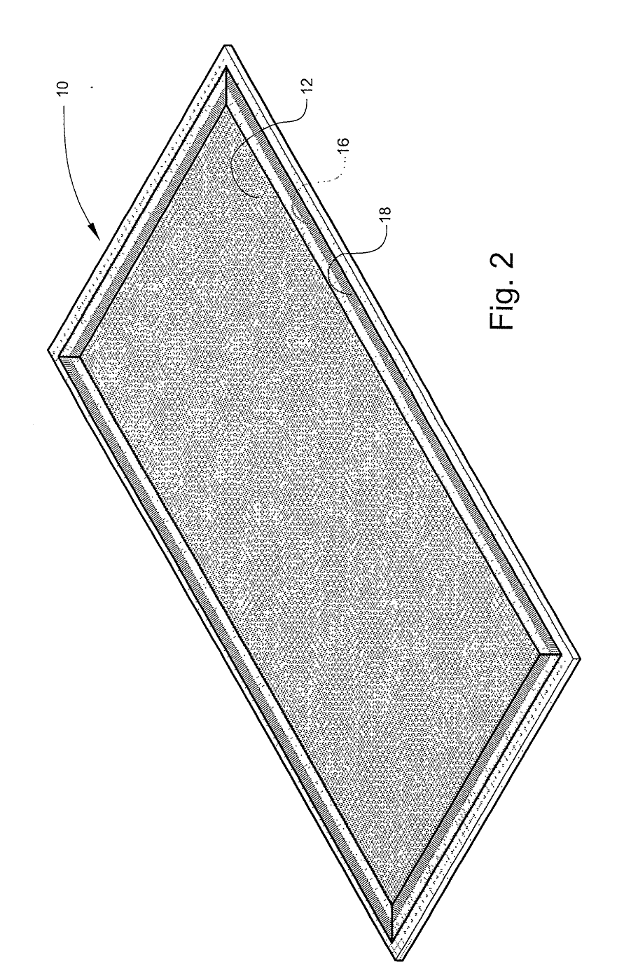

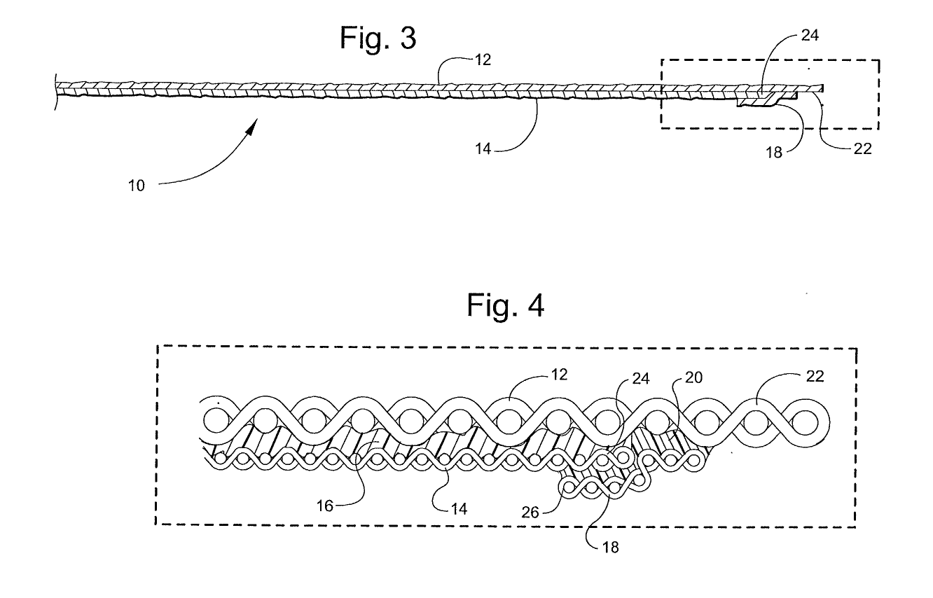

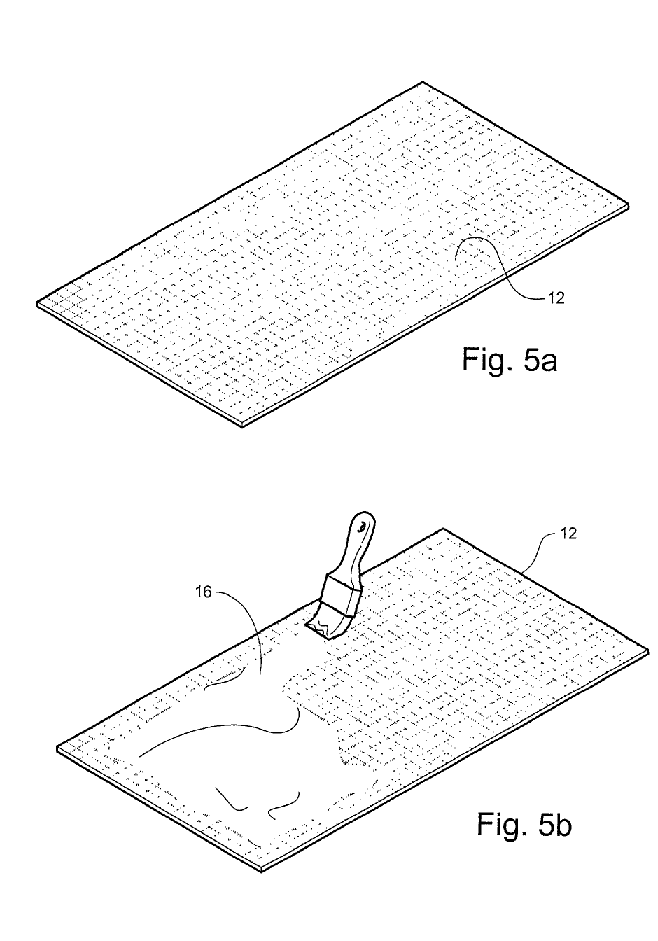

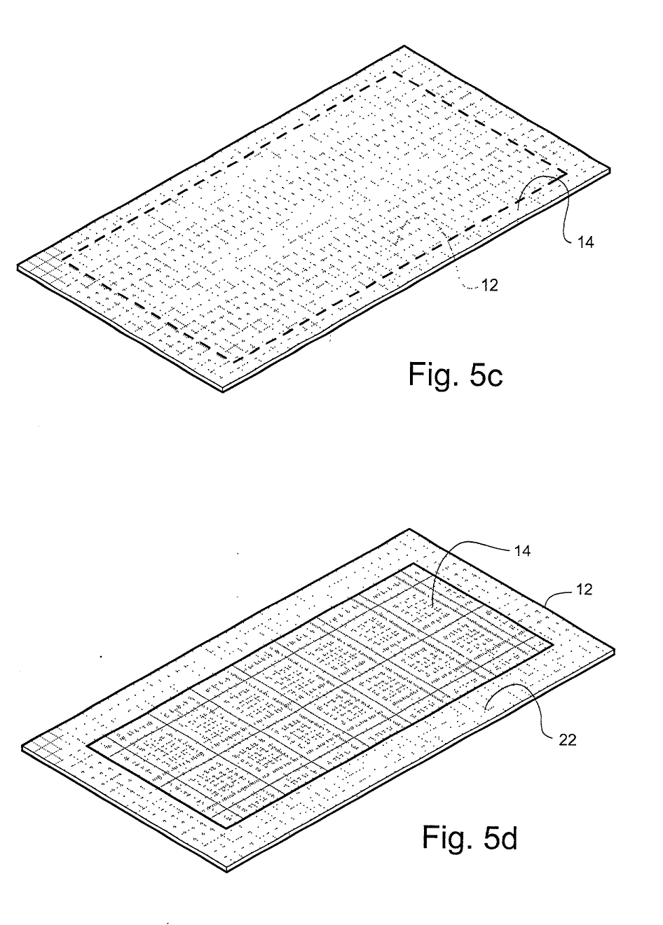

Referring first to FIGS. 1-5, the rug 10 of the preferred embodiment of the present invention is made up of an upper layer 12, a backing layer 14, an intermediate adhesive layer 16, a border strip 18 and an adhesive strip 20 between the border strip 18 and the upper and backing layers 12, 14.

The upper layer 12 is preferably formed of inexpensive cotton flat yarn loosely woven in a weight of ¼ to ⅓ pound per square foot. The upper layer 12 could also be made of synthetic yarn and could be woven from chenille yam and could be a Jacquard-like weave. The present invention could have advantage also with other types of yarns and weaves that provide a relatively inexpensive woven rug-type fabric. Typically these fabrics are made for use as rugs by themselves, often hand woven or woven on power looms.

The backing layer 14 may be of any inexpensive backing material. In the preferred embodiment, it is a cotton duck material that is substantially less expensive than the fabric of the upper layer. This backing layer 14 is bonded to the upper layer by the intermediate adhesive layer 16 that covers the area of the underside of the upper layer 12 in the area to which the backing layer 18 is bonded. This intermediate adhesive layer 16 is preferably an inexpensive latex adhesive. The backing layer 14 and the intermediate adhesive layer 16 are of a lesser peripheral extent than the upper layer 12, thereby exposing a border 22 extending around the periphery beyond the periphery of the backing layer 14. The border strip 18 is a narrow woven band that partially overlays the border 22 of the upper layer 12 and an adjacent peripheral portion 24 of the backing layer 14. The adhesive strip 20 bonds the border strip 18 to the border 22 of the upper layer 12 and to the peripheral portion 24 of the backing layer 14.

The weight of the combined upper layer 12, backing layer 14, intermediate adhesive layer 16, border strip 18 and adhesive strip 20 is approximately ½ pound per square foot or less. Typical examples of the weight of the upper layer 12, which is otherwise used as a bathmat or kitchen rug without the backing and adhesive, and the weight of the complete rug of the present invention that combines that same upper layer material with the other components to provide the stable inexpensive lightweight rug of the present invention, and the manufacturing costs, including the costs to manufacture a rug of the type of the upper layer 12 to a weight of 0.5 pound per square foot, are as follows:

| | | | | | | | | Cost of Rug | |
|---|---|---|---|---|---|---|---|---|---|
| | | | | | | | | of Upper | |
| | | | | | | | | Made Layer | |
| | | Total Weight | | | | Cost | | to a Weight | |
| Weight of | | of Rug of the | | Cost | | of Rug of | | of ½ Pound | |
| Upper | | Present | | of Upper | | the Present | | per Square | |
| Layer Alone | | Invention | | Layer Alone | | Invention | | Foot | |
| 0.22 | lb. | 0.40 | lb. | $0.48 | per | $0.58 | per | $1.09 | per |
| | per | | per | | sq. ft. | | sq. ft. | | sq. ft. |
| | sq. ft. | | sq. ft. | | | | | | |
| 0.22 | | 0.40 | | $0.58. | | $0.68 | | $1.31 | |
| 0.26 | | 0.44 | | $0.85 | | $0.95 | | $1.63 | |
| 0.26 | | 0.46 | | $0.74 | | $0.84 | | $1.42 | |
| 0.33 | | 0.55 | | $0.95 | | $1.05 | | $1.43 | |

The foregoing cost figures are approximate estimates. It is estimated that the cost of the backing layer 14, intermediate adhesive layer 16, border strip 18 and border adhesive layer 20 is approximately $0.10 per square foot, which adds approximately 10% to 20% to the cost of the upper layer alone. In comparison with a rug made of upper layer fabric at a weight of ½ pound per square foot, the rug of the present invention would cost only 50% to 60% the cost of a single layer rug of sufficient stability to serve as a general purpose rug. This is with the exception of the last line of the list, which indicates that a rug made according to the present invention, but with a weight of 0.55 pound per square inch is only 73% of the cost of a single layer rug of 0.5 pound per square foot. This demonstrates that the cost advantage diminishes markedly when the weight of the rug exceeds ½ pound per square foot and that the invention has unique application to rugs having a weight of approximately ½ pound per square foot or less.

The fabric of the woven upper layer 12 in examples of the preferred embodiment of the present invention have the following range of specifications:

| | |
|---|---|
| Warp Yarns Per Inch | 9-20 |
| Number of Picks Per Inch | 8-14 |
| Count of Warp Yarn | 2/4-2/6 |
| Count of Weft | 3 mm, 2/4 8 ply, 2/6 7 ply |
| Type of Yarn in Weft | Cotton or Cotton/Rayon |

The backing layer 14 is preferably cotton duck woven with the following exemplary specifications:

| Type of Weave: | Plain |
|---|---|
| Type of Cloth: | Cotton 2x2 |
| Count/Ply of Yarn: | 2/10 Single Ply |
| Reed per Inch: | 16 |
| Pick per Inch: | 12-13 |
| Number of Yarns in each Pick: | 2 |
| Number of Yarns in one Reed: | 2 |

The border strip 18 is preferably of the same material as the backing layer 14 woven in the form of tape.

In a commercial application of the present invention, the intermediate adhesive layer 16 and the border layer of adhesive 20 are latex adhesive made to the following specifications, with the specifications of the latex adhesive used with conventional tufted rugs being listed for comparison:

| | Latex Adhesive of | Latex Adhesive of |
|---|---|---|
| Chemical Components | Present Invention | Typical Tufted Rug |
| Natural Rubber | 20% | 10% |
| Water | 25% | 30% |
| Whiting Powder | 45% | 55% |
| CMC | 2% | 1% |
| Silicate | 4% | 2% |
| Sodium | 0.5% | 0.25% |
| Sulfur | 1% | 0.5% |
| Zinc | 0.5% | 0.25% |
| Z.D.C | 0.5% | 0.25% |
| Kasin | 0.5% | 0.25% |

From the foregoing, and particularly the water/rubber ratios, it will be apparent that the latex adhesive used with the preferred embodiment of the present invention is of higher viscosity than that of the typical latex adhesive used with tufted rugs. The reason for using the higher viscosity is that a low viscosity latex adhesive would tend to penetrate the weave of the upper level 12 and be exposed on the surface or at least visible in the upper layer, whereas a latex adhesive of relatively high viscosity would not be able to penetrate the fabric of the upper layer.

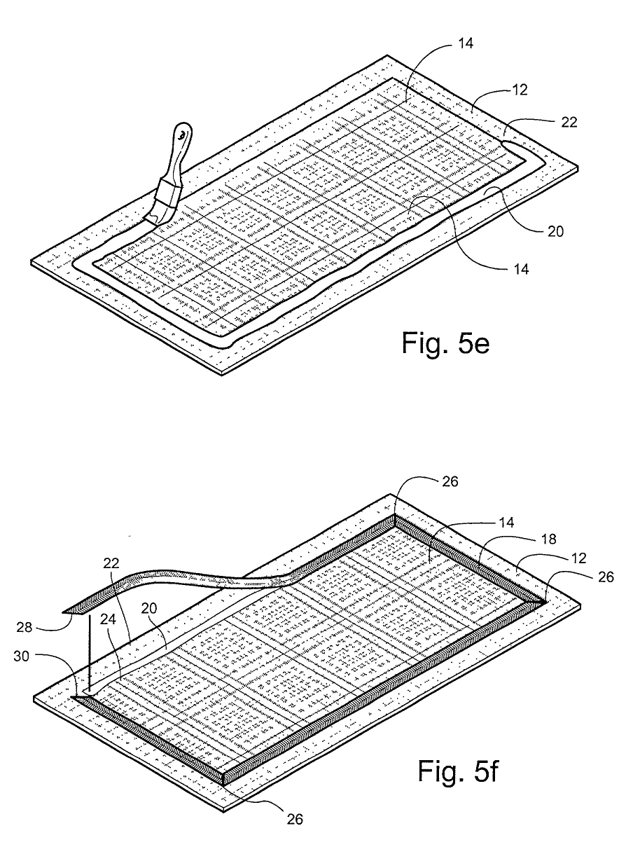

The construction of the rug of the preferred embodiment of the present invention is apparent from the steps of the manufacturing process illustrated in FIGS. 6(a)-6(f). FIG. 6(a) illustrates the upper layer 12 turned over with its underside facing upward. FIG. 6(b) illustrates the intermediate adhesive layer 12 being applied to the area of the underside of the upper layer 12 that is to be covered by the backing layer 14. FIG. 6(c) shows a piece of backing layer material applied to the underside of the upper layer 12 with the intermediate adhesive layer 16 there between. The backing layer 16 is originally applied as an oversized sheet and then subsequently trimmed to the size illustrated in FIG. 6(d), leaving the peripheral border 22 of the upper level 12. The border strip of adhesive is then applied in a narrow band of a width equivalent to the border strip 18. The adhesive strip approximately equally overlaps the peripheral edge portion 26 of the backing layer 14 and the adjacent portion of the border 22 of the underside of the upper layer 12.

Finally, the border strip 18 is placed on top of the border layer of adhesive 20. The border strip 24 is of a material similar to the cotton duck backing layer 12. It is a single continuous strip that is cut with notches at the location of the corners so that the strip can be bent to a right angle at the corners 26. When the border strip 18 is fully in place, the ends 28, 30 mate at one of the corners 26.

As thus assembled, the intermediate adhesive layer 16 bonds the backing layer 14 to the upper layer 12, and the border layer of adhesive 20 bonds the border strip 18 to both the backing layer 14 and the adjacent upper layer 12 to complete a structurally stable rug.

As a result of this construction, dimensionally stable rugs can be made of relatively large size, such as 5′×8′, 7′×9′, 8′×11 and larger, all of which sizes are larger than practical for a rug made of the material of the upper layer alone at a weight of ½ pound per square foot or less.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements, the present invention being limited only by the claims appended hereto and the equivalents thereof.

What is claimed is:

1. A lightweight stable rug comprising:
an upper layer of lightweight, relatively flaccid woven material;
a lower backing layer; and
an intermediate layer of adhesive material bonding said backing layer to said upper layer to form said lightweight stable rug.

2. A lightweight stable rug according to claim 1 and characterized further in that said upper layer of woven material is one of loosely woven chenille yarn, loosely woven flat yarn or a loosely woven Jacquard fabric.

3. A lightweight stable rug according to claim 2 and characterized further in that said upper layer of woven material is cotton.

4. A lightweight stable rug according to claim 1 and characterized further in that said upper layer weighs approximately ⅓ pound per square foot or less.

5. A lightweight stable rug according to claim 1 and characterized further in that the combined weight of the upper layer, the intermediate layer and the backing layer is approximately ½ pound per square foot or less.

6. A lightweight stable rug according to claim 5 and characterized further in that said upper layer weighs approximately 1/13 pound per square foot or less.

7. A lightweight stable rug according to claim 1 and characterized further in that said intermediate layer of adhesive material is a latex adhesive material.

8. A lightweight stable rug according to claim 1 and characterized further in that said intermediate layer is a relatively high viscosity latex adhesive material.

9. A lightweight stable rug according to claim 1 and characterized further in that said backing layer is cotton duck material.

10. A lightweight stable rug according to claim 1 and characterized further in that said backing layer is of lesser peripheral extent than said upper layer to provide a border of said upper layer beyond the periphery of said backing layer, and by a border strip partially overlaying said upper layer border and the adjacent portion of said backing layer, and a border layer of adhesive material between said border strip and said upper and backing layers to bond said border strip to said upper and backing layers.

11. A lightweight stable rug according to claim 10 and characterized further in that said border layer of adhesive material is a latex adhesive material.

12. A lightweight stable rug according to claim 11 and characterized further in that said intermediate layer of adhesive material is a latex adhesive material.

13. A lightweight stable rug according to claim 10 and characterized further in that the combined weight of the upper layer, the intermediate layer, the backing layer, the border strip and the border layer of adhesive is approximately ½ pound per square foot or less.

14. A lightweight stable rug according to claim 12 and characterized further in that the combined weight of the upper layer, the intermediate layer, the backing layer, the border strip and the border layer of adhesive is approximately ½ pound per square foot or less.
